(19) United States
(12) Patent Application Publication
(10) Pub. No.: US 2026/0204999 A1
(43) Pub. Date: Jul. 16, 2026

(54) METHOD FOR IMPROVING PERFORMANCE OF POWER SUPPLY BY POLYPHASE INTERLEAVED CIRCUIT

(71) Applicant: GUANGDONG GOSPOWER ELECTRIC TECHNOLOGY CO., LTD., Dongguan (CN)

(72) Inventors: Jiazhi Xiang, Dongguan (CN); Jiwen Lan, Dongguan (CN)

(21) Appl. No.: 19/024,025

(22) Filed: Jan. 16, 2025

(51) Int. Cl. H02M 1/00; H02M 3/00; H02M 3/335

(52) U.S. Cl. CPC H02M 1/0043; H02M 3/01; H02M 3/33592

(57) ABSTRACT

A method for improving the performance of a power supply by a polyphase interleaved circuit. By an interleaved LLC asymmetrical wave generation mode, by sensing a converter area of a primary side resonant network in secondary side driving, out-phase SRB or SRC upper tube/lower tube at the secondary side are periodically conducted transiently at the same time in an energy transmission area of an A-phase primary side to store energy in the resonant network. Before power-off, SR driving energy inserted into the converter area is stored in the resonant network, and the energy is released after the SRB or SRC is conducted transiently so that the output retention time of the complete machine will be prolonged. The method can improves the gain of the resonant converter, prolonging the input power-down retention time and improving the dynamic performance of the power supply.

### TECHNICAL FIELD

The present disclosure relates to the technical field of resonant converters, and particularly relates to a method for improving performance of a power supply by a polyphase interleaved circuit.

### BACKGROUND

Thanks to the advantages of high efficiency and excellent electromagnetic interference (EMI) performance, an inductor-inductor-capacitor (LLC) has become a popular direct current/direct current topology in power supply applications. With the increase of requirements on single power supply unit (PSU) power, the interleaving technology has become an effective method of improving the power level without significantly upgrading a power supply device. In recent years, a three-phase interleaved LLC, as typical interleaved topology, has been widely applied to telecommunication and server PS. Compared with parallel topology, the three-phase interleaved LLC can significantly reduce the current ripple and easily realize current balance. Combined with a special magnetic component design, the sizes of an inductor and a transformer can also be reduced. In addition to a driving intelligent control strategy, the retention time can be prolonged. Under the same output power condition, the retention time of the LLC is limited by the volume of an input capacitor. Without replacing a large-capacity capacitor or increasing a special circuit such as a Baby-boost circuit, it is hard to improve the output retention time. However, for a multi-channel interleaved LLC converter, the conduction angle of an SR rectifier tube of the secondary side can be adjusted, so that part of the energy is stored in the transformer. When the input is powered off, the energy is then released, so that the purpose of prolonging the retention time is achieved.

Therefore, it is necessary to provide a method for improving performance of a power supply by a polyphase interleaved circuit, so as to improve the gain of the resonant converter, prolong the input power-down retention time and improve the dynamic performance of the power supply.

### BRIEF SUMMARY OF THE INVENTION

The present disclosure discloses a method for improving performance of a power supply by a polyphase interleaved circuit and relates to a three-phase LLC resonant converter, particularly to a three-phase interleaved LLC resonant full-wave rectification converter, which is suitable for three-phase interleaved LLC full-wave rectification and can effectively solve the technical problems involved in the background art.

In order to achieve the above objective, the present disclosure adopts the following technical solution:

A method for improving performance of a power supply by a polyphase interleaved circuit, including the following steps:
S1, determining a circuit structure, wherein a circuit is divided into a primary side and a secondary side, the primary side is provided with a plurality of primary phases, the secondary side is provided with a plurality of primary phases, the primary phases correspond to the primary phases one by one and phase dead zones are spaced by a fixed phase difference, and determining dead zone time of each of the primary phases;
S2, monitoring an input voltage or an output voltage, and determining whether power-down occurs; and
S3, during power-down, conducting a certain secondary phase not corresponding to the primary phase at the dead zone time of the certain primary phase.

Specifically, disclosed is a three-phase interleaved LLC circuit, which is applied to a high power density. The volume space is limited, the input large capacitance is not increased, and the retention time of the output voltage is prolonged through phase-staggered short-circuiting. The primary side of the circuit has three LLC half bridges, 6 MOSs, and 3 groups of drivers. The secondary side has three groups of full-bridge rectifiers, 12 MOSs, and 6 groups of drivers. The three groups of resonant networks include primary transformers, resonant inductors, and resonant capacitors. The output end is an output electrolytic filter, and a switching tube of a secondary side full-wave rectifying circuit is intelligently controlled. By intelligently controlling the switching tube of a secondary side full-wave rectifying circuit, the gain of the resonant converter is improved, the input power-down retention time is prolonged, and in addition, the dynamic performance of the power supply can also be improved.

As a preferred improvement of the present disclosure, the primary phase is an LLC half bridge, and the secondary phase is a full-bridge rectifier.

As a preferred improvement of the present disclosure, there are 3-6 primary phases. Specifically, by an interleaved LLC asymmetrical wave generation mode, by sensing a converter area of a primary side resonant network in secondary side driving, phase-staggered SRB or SRC upper tube/lower tube at the secondary side is periodically conducted transiently at the same time in a dead zone where an A-phase primary side works to store energy in the resonant network. Before power-off, SR driving energy inserted into the converter area is stored in the resonant network, and the energy is released after the SRB or SRC is conducted transiently, so that the output retention time of the complete machine will be prolonged. This technology implemented is not limited to a three-phase architecture, and can be implemented in a six-phase architecture. This wave generation mode uses an existing switching time node as an asymmetrical wave generation technology, and in the known technology, the SR leading edge must be calculated complexly. The difference between this wave generation mode and the known mode lies in that behaviors of a resonance current (ILr) and an excitation current (ILm) at the primary side are inconsistent. The known technology is implemented when the two currents are equal, but this patent is implemented when the two currents are in different stages.

As a preferred improvement of the present disclosure, there are 3 primary phases which are defined as a phase A, a phase B, and a phase C in sequence according to a phase sequence; during power-down, the secondary phase corresponding to the phase B is conducted in the dead zone time of the phase A, or in the dead zone of the phase B, the secondary phase corresponding to the phase C is conducted.

As a preferred improvement of the present disclosure, during power-down of the circuit, conduction time is T_{phaseshift},

$${T}_{phaseshift} = \frac{{V}_{error}}{{V}_{error . max}} * {T}_{setting . max} - {T}_{setting . min} ,$$

T_{setting.max} is a maximum pulse width, T_{seting.min} is a minimum pulse width, Vₑᵣᵣₒᵣ is a feedback error component of the output voltage, V_{error.max} is a maximum value of the feedback error component of the output voltage, Vₑᵣᵣₒᵣ=(V_{fb}−V_{ref})*Kₚ*Kᵢ, V_{fb} is the output voltage, V_{ref} is a reference value of the output voltage, and Kₚ, Kᵢ is a loop operation coefficient.

As a preferred improvement of the present disclosure, the T_{seting.min} is 50 ns, T_{setting.max} is the dead zone time corresponding to the primary phase, V_{error.max} is 5%, and the circuit is subjected to voltage loop control.

As a preferred improvement of the present disclosure, in step S2, after the input voltage is less than a set value Vac_out, power-down of the circuit is determined; and if an output voltage drop exceeds 5%, power-down of the circuit is determined.

As a preferred improvement of the present disclosure, in step S3, during power-down, a switching frequency of the circuit is decreased first, and when the switching frequency is decreased to Tfp, the secondary phase is conducted.

As a preferred improvement of the present disclosure, the Tfp=Fswmin=Frmin+10 kHz, and Frmin is the lowest resonant frequency of the primary phase.

The present disclosure has the beneficial effects as follows:

In a voltage discharge process of an HVDC bus, since the turn ratio of the transformer is the ratio of a fixed gain to a maximum LLC resonant network gain, the output voltage is decreased finally; after a strategy is pitched in, the gain can be improved (by opening the SR driving in the dead zone of the primary side), and the output voltage is pulled back transiently, so that the output retention time can be prolonged.

### BRIEF DESCRIPTION OF THE SEVERAL VIEWS OF THE DRAWINGS

In order to describe the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without making creative efforts.

FIG. 1 is a schematic diagram of an interleaved circuit;

FIG. 2 is a flowchart of a method for improving performance of a power supply by a polyphase interleaved circuit provided by the present disclosure;

FIG. 3 is a schematic diagram of three-phase interleaved LLC driving;

FIG. 4 is a schematic diagram of three-phase LLC and SR driving dead zone control;

FIG. 5 is a schematic diagram of a phase shift curve;

FIG. 6 is a schematic diagram of control of a phase shift pulse width of a driving dead zone;

FIG. 7 is a three-phase interleaved LLC driving and resonant current;

FIG. 8 is phase-staggered short circuiting of the three-phase interleaved LLC driving and resonant current; and

FIG. 9 is a three-phase resonant current and output voltage of phase-staggered short-circuiting.

### DETAILED DESCRIPTION OF THE INVENTION

The technical solution in embodiments of the present disclosure will be clearly and completely described below with reference to the embodiments of the present disclosure.

Apparently, the described embodiments are merely a part, rather than all of the embodiments, of the present disclosure. On the basis of the embodiments in the present disclosure, all other embodiments acquired by those of ordinary skill in the art without making creative efforts fall within the scope of protection of the present disclosure.

It is to be noted that all directional indications (for example, upper, lower, left, right, front, back and the like) in the embodiments of the present disclosure are merely used for explaining relative position relations, moving conditions and the like among components in a certain special gesture (as shown in the drawings). If the special gesture changes, the directional indications change correspondingly.

In addition, the descriptions such as “first” and “second” are merely used for a description purpose rather than being construed as indicating or implying relative importance or implicitly indicating the quantity of indicated technical features. Thus, features defining “first” and “second” may expressively or implicitly include at least one feature. In the description of the present disclosure, unless otherwise specified, “a plurality of” means at least two, for example, two, three and the like.

In the present disclosure, unless otherwise specified and defined, the terms “connect”, “fix”, and the like shall be understood in a broad sense. For example, “fix” can be a fixed connection or detachable connection or integrated connection; can be a mechanical connection or electrical connection; or direct connection or an indirect connection through an intermedium, and can be internal communication of two components or an interactive relationship of the two components, unless otherwise defined. Those of ordinary skill in the art may understand the specific meaning of the terms in the present disclosure under specific circumstances.

In addition, the technical solutions of the embodiments of the present disclosure may be combined with one another based on implementation by those of ordinary skill in the art. When the technical solutions contradict each other in combination or may not be realized, it is to be considered that there is no combination of the technical solutions, which shall not fall into the protection scope of the present disclosure.

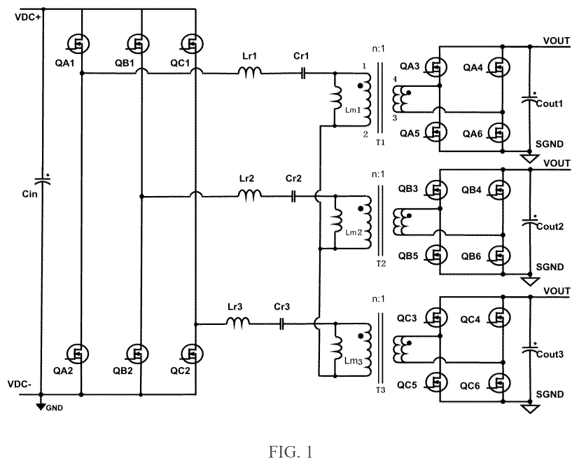

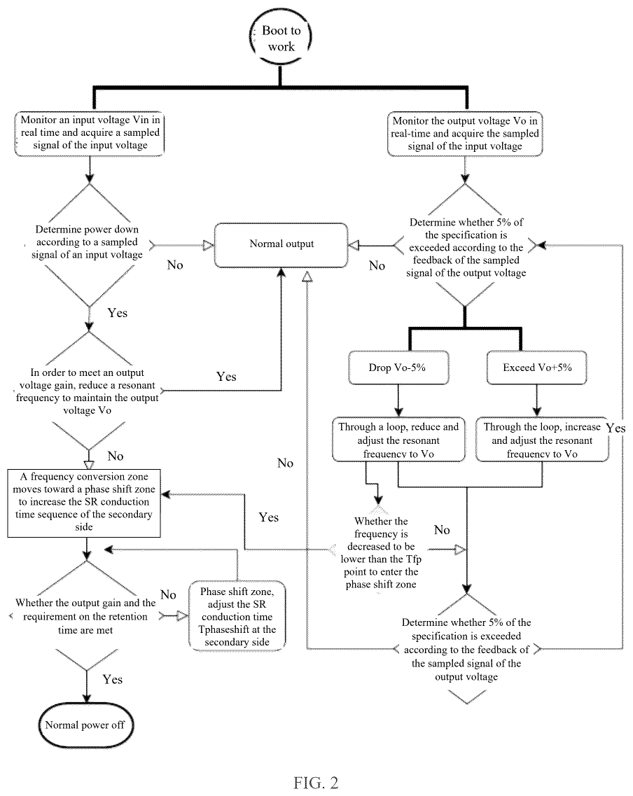

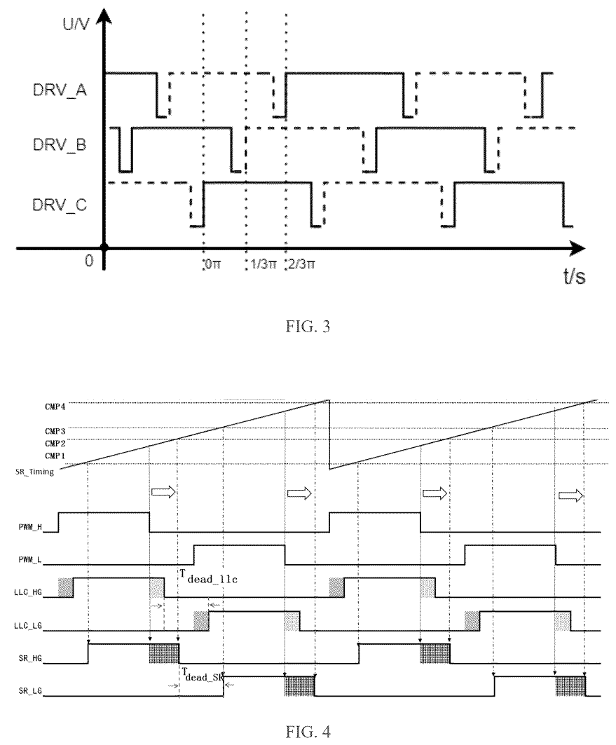

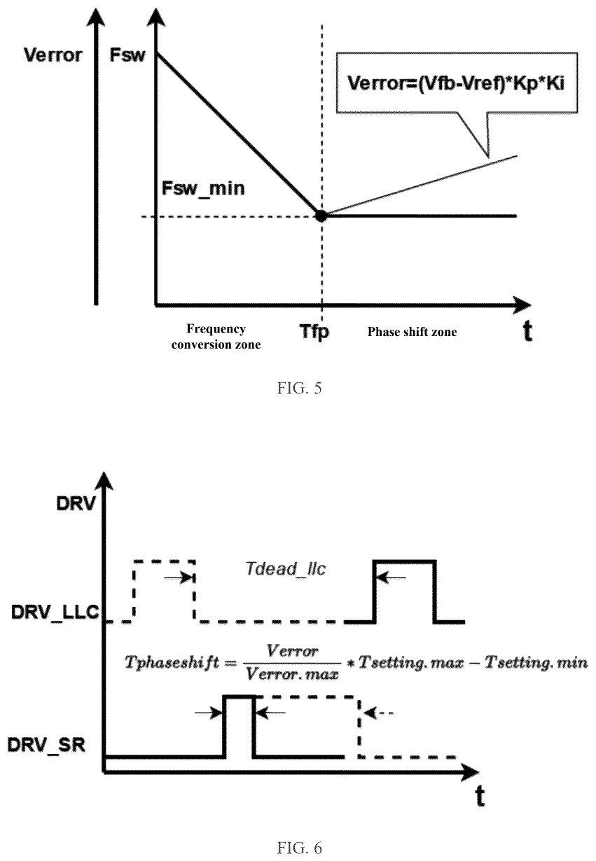

The present disclosure aims to prolong the retention time of three-phase LLC interleaved topology and improve the performance of the power supply. As shown in FIG. 1, the primary side is three-phase interleaved LLC “Y”-type topology, and the secondary side rectifies SR full-wave rectification synchronously. Driving of three-phase LLC at the primary side is respectively phase A DRV_A, defined as a group of complementary driving QA1, QA2; phase B DRV_B, defined as a group of complementary driving QB1, QB2; and phase C DRV_C, defined as a group of complementary driving QC1, QC2; the wave generation interval for each group of driving is 1/3π, and there is a working dead zone, as shown in FIG. 3. In the DRV_A legend, the solid line is a driving waveform of QA1 and the dotted line is a driving waveform of QA2. In the DRV_B legend, the solid line is a driving waveform of QB1 and the dotted line is a driving waveform of QB2. In the DRV_C legend, the solid line is a driving waveform of QC1 and the dotted line is a driving waveform of QC2. A circuit control flowchart is shown in FIG. 2.

The implementation mode of the present disclosure is as follows:

A sample is sampled from the input end to AC to monitor the input voltage, so as to determine power-down (CASE 1) with the set value Vac_out. The power-down ground is that the AC sampling signal is made at the primary side, and a condition can be triggered if the value is less than the set value Vac_out. The gain of the voltage Vfb of the output end converted drops by 5% (CASE 2), and SR can also be triggered to be conducted in the dead zone of the primary side.

When the three-phase interleaved circuit works in a steady state, driving at the secondary side and driving at the primary side of the three-phase interleaved LLC are bound and associated, with the binding relation as follows:

AQ1 and QA2 at the primary side are divided into two groups corresponding to the secondary side. QA3 and QA6 in a positive semi-cycle of the resonance current are in one group and are switched simultaneously. QA4 and QA5 in a negative semi-cycle of the resonance current are in one group and are switched simultaneously;

QB1 and QB2 at the primary side are divided into two groups corresponding to the secondary side. QB3 and QB6 in a positive semi-cycle of the resonance current are in one group and are switched simultaneously. QB4 and QB5 in a negative semi-cycle of the resonance current are in one group and are switched simultaneously;

QA1 and QA2 at the primary side are divided into two groups corresponding to the secondary side. QC3 and QC6 in a positive semi-cycle of the resonance current are in one group and are switched simultaneously. QC4 and QC5 in a negative semi-cycle of the resonance current are in one group and are switched simultaneously.

LLC and SR dead zones are shown in FIG. 4. There are 4 comparators and two groups of PWM controllers in the MCU. The PWM controllers are respectively PWM_H/PWM_L to control upper tube/lower tube driving, and leading/trailing edge adjusting zones are reserved, such as a shadow area of LLC_HG/LLC_LG driving, which is a fixed dead zone where the primary side is inserted according to the resonant frequency.

After the topology of the transformer is confirmed, parameters of each phase LLC resonant network Lm, Lr, and Cr are known conditions. The highest resonant frequency is

$${F}_{rmax} = \frac{1}{2 π \sqrt{Lr * Cr}} ,$$

and the lowest resonant frequency is

$${F}_{rmin} = \frac{1}{2 π \sqrt{( Lr + Lm ) * Cr}} .$$

In the above circuit, when the input is powered down or the output drops out of specification, the resonant network frequency at the primary side will be reduced first to improve the gain till the switching frequency reaches Tfp (can be set at Fswmin=Frmin+10 kHz), as shown in the phase shift curve diagram in FIG. 5. After the switching frequency is decreased to the Tfp point, the frequency will not be decreased continuously to improve the gain, so that the output retention time is maintained; at SRMOS driving at the secondary side, SR MOS will be transiently conducted in the dead zone at the primary side of the other two phases, the maximum/minimum pulse width is limited by MCU at the Tphaseshift turn-on time, and the minimum pulse width can be set as a fixed value Tsetting.min. For example, by using STM32G4 series, the typical value can be set as 50 ns, the maximum pulse width Tsetting.max is Tdead_llc, and the time will be updated in real time according to the resonant frequency; the Tphaseshift needs to be calculated through Vfb and the error component Verror fed back, the maximum value of the error range of the Verror.max output voltage Vfb which is usually +5%, and the reference value Vᵣₑf loop proportional (Kp) integral (Ki), the formula being as follows: Vₑᵣᵣₒᵣ=(V_{fb}−V_{ref})*Kₚ*Kᵢ,

$${T}_{phaseshift} = \frac{{V}_{error}}{{V}_{error . max}} * {T}_{setting . max} - {T}_{setting . min} .$$

The energy after phase-staggered conduction is triggered is stored in the LLC resonant cavity and is released cycle by cycle, so that the output gain of the power supply is improved.

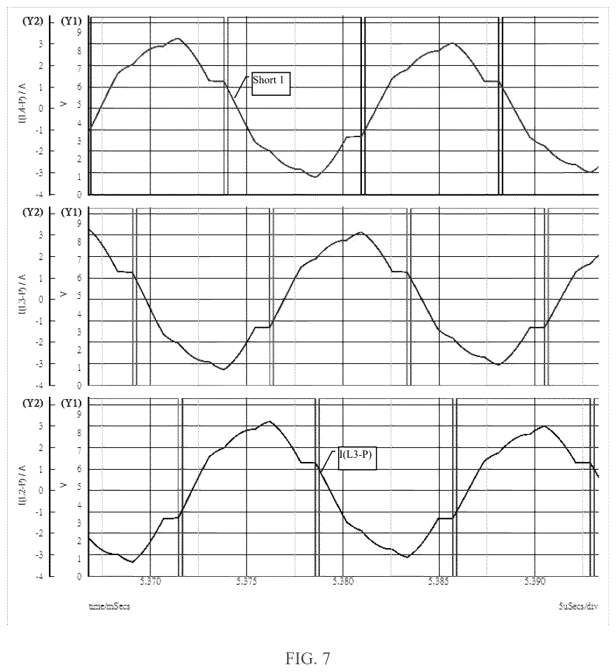

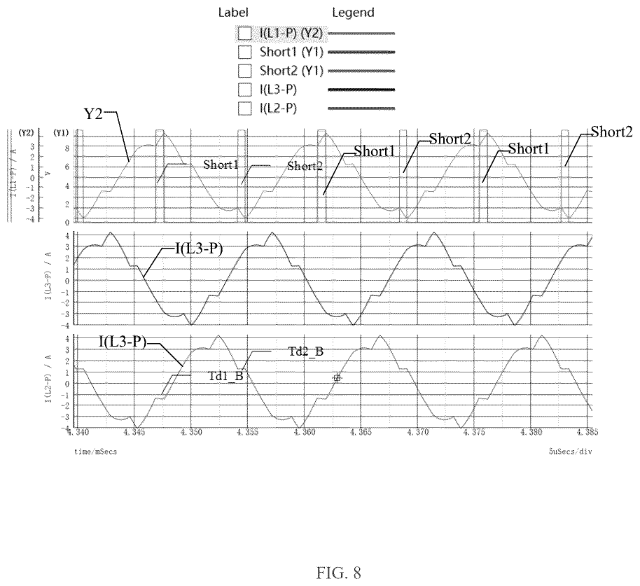

Symmetrical wave generation working waveform for three-phase interleaved LLC is shown in FIG. 7; different modes for the asymmetrical wave generation working waveform for three-phase interleaved LLC mainly aim at SR driving at the secondary side, as shown in FIGS. 7-8. After the condition is triggered, the phase difference of the resonant current of the three-phase interleaved LLC at the primary side is 60°, and there are two dead zones Td1/Td2 at the head and tail of each phase full cycle. The LLC resonant current of the phase A at the primary side and SR driving of the phase B are shown in the figure, and Td1_B and Td2_B are the dead zones of the phase B at the primary side.

IL1 is the resonant current of the phase A at the primary side, IL2 is the resonant current of the phase B at the primary side, and IL3 is the resonant current of the phase C at the primary side; Short1 is the third group of pre-conducted SR driving (driving QB3 and QB5 simultaneously) of the phase B at the secondary side, and Short2 is the fourth group of pre-conducted SR driving (driving QB4 and QB6 simultaneously) of the phase B at the secondary side.

The gain or output voltage abnormal condition (Case 1 or Case 2) of the converter triggers the resonant frequency to be adjusted to the phase shift zone. The start time of short3 conducted driving is front Td1_B of the phase A at the primary side, i.e., the positive semi-cycle of the resonant current of the phase A, and the start time of short4 conducted driving is back Td2_B of the phase A at the primary side, i.e., the negative semi-cycle of the resonant current of the phase A. The pulse widths of Short3 and Short4 driving can be adjusted, and a calculation formula can refer to Tphaseshift.

SR driving conduction of the phase shift zone has the following principle:
(1) Phase interleaved conduction: SRB short circuit triggers conduction in the dead zone of the DRV_A phase, and SRC short circuit triggers conduction in the dead zone of DRV_B phase;
(2) At the condition triggering time, to further facilitate control, PWM is triggered in full cycle, i.e., the SR turn-on point at the secondary side starts the triggering mechanism after the cycle is finished after SRB and SRC power down, so as to conduct the secondary side in the dead zone of the phase A in the next cycle.

In a voltage discharge process of an HVDC bus, since the turn ratio of the transformer is the ratio of a fixed gain to a maximum LLC resonant network gain, the output voltage is decreased finally; after a strategy is pitched in, the gain can be improved (by opening the SR driving in the dead zone of the primary side), and the output voltage is pulled back transiently, so that the output retention time can be prolonged.

A schematic circuit diagram of the resonant converter of the three-phase LLC “Y” type interleaved full-wave rectifier is shown in FIG. 1. During normal work, the phase difference of three groups of driving is 60°. Through asymmetrical wave generation, SR driving of QB3, QB6 (or QB4, QB5) at the secondary side is conducted to one LLC resonant network at the primary side, such as DRV_B, DRV_C; then it is expanded and applied to the multi-interleaved circuit (six-interleaved), and with reference to the above work logic, a deviation relation is shown in table 1.1:

TABLE 1.1
Phase-staggered correlation chart between
six-phase LLC interleaved driving and SR driving

| | LLC driving at | SR driving at | | SR conducted driving | |
|---|---|---|---|---|---|
| Group | primary side | secondary side | | in phase shift zone | |
| First group | DRV_A | SR1 | SR2 | / | / |
| Second group | DRV_B | SR3 | SR4 | Short1 | Short2 |
| Third group | DRV_C | SR5 | SR6 | Short3 | Short4 |
| Fourth group | DRV_D | SR7 | SR8 | Short5 | Short6 |
| Fifth group | DRV_E | SR9 | SR10 | Short7 | Short8 |
| Sixth group | DRV_F | SR11 | SR12 | Short9 | Short10 |

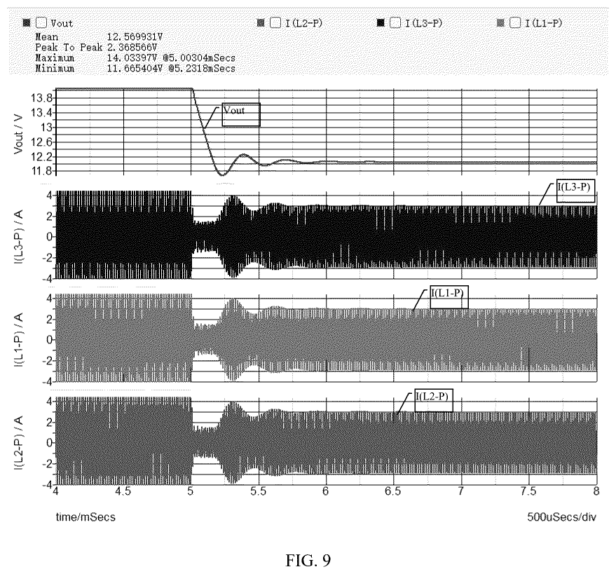

It can be seen from FIG. 9 that after a three-phase LLC interleaved control strategy is used, three output voltages can be transiently increased to 2.0V. It is converted to about 30 Vdc at the primary side by means of the turn ratio 15:1 of the transformer. That is, the gain of the three-phase LLC converter in the time period is increased by 30V, and the retention time of the output voltage is prolonged.

Although the embodiments of the present disclosure have been disclosed above, the present disclosure is not merely limited to applications listed in the description and the embodiments. They can be completely applied to various fields suitable for the present disclosure. Those skilled in the art can easily achieve additional modifications. Therefore, the present disclosure is not limited to specific details and drawings described herein without deviating from a general concept defined by the claims and the equivalent scope.

What is claimed is:

1. A method for improving performance of a power supply by a polyphase interleaved circuit, comprising the following steps:
S1, determining a circuit structure, wherein a circuit is divided into a primary side and a secondary side, the primary side is provided with a plurality of primary phases, the secondary side is provided with a plurality of primary phases, the primary phases correspond to the primary phases one by one and phase dead zones are spaced by a fixed phase difference, and determining dead zone time of each of the primary phases;
S2, monitoring an input voltage or an output voltage and determining whether power-down occurs; and
S3, during power-down, conducting a certain secondary phase not corresponding to the primary phase at the dead zone time of the certain primary phase.

2. The method for improving performance of a power supply by a polyphase interleaved circuit according to claim 1, wherein the primary phase is an LLC half bridge, and the secondary phase is a full-ridge rectifier.

3. The method for improving performance of a power supply by a polyphase interleaved circuit according to claim 1, wherein there are 3-6 primary phases.

4. The method for improving performance of a power supply by a polyphase interleaved circuit according to claim 1, wherein there are 3 primary phases which are defined as a phase A, a phase B, and a phase C in sequence according to a phase sequence; during power-down, the secondary phase corresponding to the phase B is conducted in the dead zone time of the phase A, or in the dead zone of the phase B, the secondary phase corresponding to the phase C is conducted.

5. The method for improving performance of a power supply by a polyphase interleaved circuit according to claim 1, wherein during power-down of the circuit, conduction time is T_{phaseshift},
$${T}_{phaseshift} = \frac{{V}_{error}}{{V}_{error . max}} * {T}_{setting . max} - {T}_{setting . min} ,$$
T_{setting.max} is a maximum pulse width, T_{seting.min} is a minimum pulse width, Vₑᵣᵣₒᵣ is a feedback error component of the output voltage, V_{error.max} is a maximum value of the feedback error component of the output voltage, Vₑᵣᵣₒᵣ=(V_{fb}−V_{ref})*Kₚ*Kᵢ, V_{fb} is the output voltage, Vref is a reference value of the output voltage, and Kₚ, Kᵢ is a loop operation coefficient.

6. The method for improving performance of a power supply by a polyphase interleaved circuit according to claim 5, wherein the T_{seting.min} is 50 ns, T_{setting.max} is the dead zone time corresponding to the primary phase, V_{error.max} is 5%, and the circuit is subjected to voltage loop control.

7. The method for improving performance of a power supply by a polyphase interleaved circuit according to claim 1, wherein in step S2, after the input voltage is less than a set value Vac_out, power-down of the circuit is determined; and if an output voltage drop exceeds 5%, power-down of the circuit is determined.

8. The method for improving performance of a power supply by a polyphase interleaved circuit according to claim 1, wherein in step S3, during power-down, a switching frequency of the circuit is decreased first, and when the switching frequency is decreased to Tfp, the secondary phase is conducted.

9. The method for improving performance of a power supply by a polyphase interleaved circuit according to claim 8, wherein the Tfp=Fswmin=Frmin+10 kHz, and Frmin is the lowest resonant frequency of the primary phase.
